(19) United States
(12) Patent Application Publication
(10) Pub. No.: US 2004/0062194 A1
(43) Pub. Date: Apr. 1, 2004

(54) Information arrangement in sdh or sonet networks

(76) Inventors: Dag Gisle Kustas, Fevik (NO); Magne Sigbjorn Stormo, Grimstad (NO); Karl Peder Laulo, Arendal (NO); Par Larsson, Stockholm (SE)

Correspondence Address: ERICSSON INC., 6300 LEGACY DRIVE, M/S EVR C11, PLANO, TX, 75024, US

(21) Appl. No.: 10/333,102

(22) PCT Filed: Jul. 17, 2001
(86) PCT No.: PCT/NO01/00309

(30) Foreign Application Priority Data
Jul. 17, 2000 (NO) 20003648

(51) Int. Cl. H04L 12/26; G06F 11/00

(52) U.S. Cl. 370/216

(57) ABSTRACT

An new arrangement for object handling and a new information data object in redundancy protected networks according to SDH or SONET comprising one or more protected items and protection items. In a protected layer, groups of first information objects representing linked protected items are globally addressable by means of at least one respective GDIP object, and the first information objects are made addressable relative to the GDIP object. In a protection layer, second information objects representing protection items are globally addressable. The arrangement and object addressing simplifies object handling in system supervision, operation, monitoring, control, management or the like.

### TECHNICAL FIELD

This invention relates to an object handling arrangement for supervision or management of systems that terminate SDH or SONET signals in accordance with related ITU-T, ETSI, ANSI and TTC standards. The invention is particularly useful in providing a manageable user interface in such systems that become complex by having extensive redundancy provisions.

### THE PROBLEM AREA

Information models or associated information arrangements in accordance with ITU-T and ETSI recommendations or standards define the different layers of the SDH termination as separate objects or entities. Accordingly, the addressing of each of the SDH objects is global, and, hence, there is no identifiable object that represents the common status of objects in the hierarchy for a physical connection. Also, the addressing becomes complex and more complicated when the number of SDH or SONET terminations in a system increases. Furthermore, when introducing protection arrangements or solutions (redundancy on network layers), then the handling aspects become more complicated for the network operator, supervisor or manager as the number of objects to operate, supervise, monitor, control or manage increase significantly.

For a background on the related area, reference is made to the ITU-T, ETSI, ANSI and TTC standards that are applicable to systems that terminate SDH or SONET signals. Hence, in the following description, the ETSI terminology is used, but the principles covered are valid for ANSI and TTC standards as well.

### KNOWN SOLUTIONS

According with ETSI or ITU-T standards or recommendations for termination of SDH STM-n signals, the following termination layers are defined (ITU-T G.707):

For STM-1 termination:

Regenerator Section(RS)—section between regenerators

Multiplex Section (MS)—Section between multiplexors

Virtual Container level 4—Path layer, VC-4

Virtual Container level 12—Path layer, VC-12

In order to monitor, supervise, manage and/or control a termination such as the STM-1 above, the termination layers can be represented by handling objects that can be addressed by the operator, supervisor, manager or the like of the system, e.g. by commands.

By means of protocols that follow the structures of SDH, SONET and/or TTC, it is also possible to implement different protection schemes or arrangements in order to increase the availability of a system that terminates SDH or SONET signals in accordance with the previously mentioned ITU-T, ETSI, ANSI and/or TTC standards.

To illustrate a situation according to the above, reference is made to FIG. 1 which shows a typical configuration of a protected system with MSP1+1 protection. In such configurations, the traffic carried by one of the MS terminations is protected by the other, and, if the active link fails, then the traffic is moved to the other (standby) link, and no traffic is lost.

In a known solution disclosed by Ericsson, the addressing of SDH or SONET terminations such as, for example, MS, VC4 and VC12 objects, is handled by using a new object called SDIP that represents all the SDH or SONET layers for a physical connection contained in the termination. The SDIP object also includes global state information showing the state of the sub-objects (e.g. MS, VC-4 and VC-12) contained in the termination. In the following, by way of example, that solution will be explained in more detail by ETSI terminology and with reference to the accompanying FIG. 1:

Overall object: “SDIP”, representing (or including):

a) two (2) instances of MS (Multiplex Section) for protection purposes (MSP 1+1 or MSP1:1);

b) one (1) instance of VC-4; and

c) up to a maximum of sixty three (63) instances of VC-12.

In the above example of a known arrangement, addressing of any of the sub-objects (i.e. MS, VC-4 or VC-12) is done by looking up the SDIP object in a table. Then, this object points to the contained objects. It should be noted that the above mentioned Regenerator Section (RS) typically present is intentionally not considered in this example since this example is independent of that layer. If the RS had been included, then it would appear as one RS object connected to each MS object.

### PROBLEMS WITH KNOWN SOLUTIONS

The existing arrangement or model of grouping all termination objects (such as VC12, VC4; also referred to as protected layers) and the MS objects (also referred to as the protection layer), may be useful when the number of included objects is small, such as in the case of MSP1+1 or MSP1:1. However, if the existing arrangement or model is to be used for other protection schemes, for instance as in MSP1:N (N=4,8, etc), it is easy to see that the number of included objects will increase dramatically. Hence, the addressing becomes considerably more complex and demanding.

To illustrate the situation, reference is made to FIG. 2 where a typical configuration of MSP1:4 is shown. MSP 1:4 means that the traffic carried by the four links on the top of the figure (marked as active) is protected means of the spare or standby link. The four protected links, therefore, belongs to a group that shares the same spare or standby link. If one of these protected links fails, then the traffic is moved to the standby link, and no traffic is lost.

The problem with the existing solution is readily apparent when different protection arrangements are to be represented to a system supervisor, for instance in a MSP 1:N case (i.e. Multiplex Section Protection, N=1,4,8, etc.). Especially for cases of N=4,8, etc., if the existing information arrangement or model should be used, this would give a very large grouping object. This can be seen from the SDIP object in the example illustrated by FIG. 2.

To illustrate how system state will be presented to a supervisor or manager supervising or managing a system as the one shown in FIG. 4, the following table I shows a typical example for the SDIP:

The present invention provides a novel arrangement for object handling in object supervision, operation, monitoring, control, management or the like in redundancy protected networks according to SDH or SONET, said networks comprising a plurality of protected items and at least one protection item, wherein at least one group of first information objects representing linked protected items is globally addressable by means of at least one respective GDIP object, said first information objects being addressable relative to said GDIP object.

Preferably, in the novel arrangement for object handling of the invention second information objects representing said protection items are globally addressable.

The present invention further provides an information data object in redundancy protected networks according to SDH or SONET comprising one or more protected items and protection items, wherein the information data object, in use, is a GDIP object being identifiable as an addressable data structure held in one or more registers in a computer and comprises pointers to a set of objects representing protected items.

The present invention further provides an object arrangement in a redundancy protected network according to SDH or SONET for improved supervision, operation, monitoring, control, management or the like of network items represented by objects, the objects being according to ITU-T, ETSI, ANSI and/or TTC standards, comprising at least one globally addressable GDIP object, each said at least one GDIP object being an information object for information pertaining to a set of associated objects, the set of associated objects representing a plurality of terminations essentially at a level according to ITU-T VC12 and one termination essentially at a level according to ITU-T VC4.

Preferably, in the object arrangement of the invention, each object contained in said set of associated objects is addressable relative to an address of the associated GDIP object.

The present invention further provides an improvement in a redundancy protected network according to SDH or SONET, wherein the improvement includes layering objects representing terminations into at least one protected layer for protected terminations and at least one protection layer for protecting terminations, and grouping objects representing linked terminations of the at least one protected layer by means of relative addressing into one ore more respective GDIP objects.

TABLE I

| SDIP | LAYER | STATE | BLS | FAULT | TYPE | PL/TTI | LST |
|---|---|---|---|---|---|---|---|
| sdip | | state | bls | | | | |
| | MS0 | state | bls | fault | | | lst |
| | MS-1 | state | bls | fault | | | lst |
| | MS-2 | state | bls | fault | | | lst |
| | MS-3 | state | bls | fault | | | lst |
| | MS-4 | state | bls | fault | | | lst |
| | VC4-0 | state | bls | fault | type | pl/tti | lst |
| | VC4-1 | state | bls | fault | type | pl/tti | lst |
| | VC4-2 | state | bls | fault | type | pl/tti | lst |
| | VC4-3 | state | bls | fault | type | pl/tti | lst |
| | VC12-0 | state | bls | fault | type | | lst |
| | VC12-1 | state | bls | fault | type | | lst |
| | . | . | . | . | . | | . |
| | . | . | . | . | . | | . |
| | . | . | . | . | . | | . |
| | VC12-252 | state | bis | fault | type | | lst |

The addressing problem can be seen to worsen even further when an MSP1:8 configuration using the existing information arrangements or model is considered. An MSP1:8 configuration would give a handling object (SDIP) containing 9 MS, 8 VC-4 and 504 VC-12 objects. That is, one SDIP object groups 504 VC-12 terminations which actually belongs to 8 different VC-4 paths, but are protected by means of one common standby MS link.

### OBJECTS OF THE INVENTION

In accordance with the problems described above, it is an object of the invention to simplify the handling and/or presentation of SDH or SONET handling objects for system and object supervision, operation, monitoring, control or management, and to overcome shortcomings of existing systems in this regard.

### BRIEF DESCRIPTION OF THE INVENTION

According to the present invention, a new arrangement for grouping or representing handling objects is provided in order to support any type of protection scheme with a simple addressing of all objects included.

### BRIEF DESCRIPTION OF THE DRAWINGS

FIG. 1 is a schematic drawing of an arrangement having MSP1+1 Protection of prior art with its object included in an SDIP;

FIG. 2 is a schematic drawing of an exemplary arrangement of MSP1:4 configuration of a known system;

FIG. 3 is a schematic drawing of an exemplary SDH interface using MSP 1:4 protection;

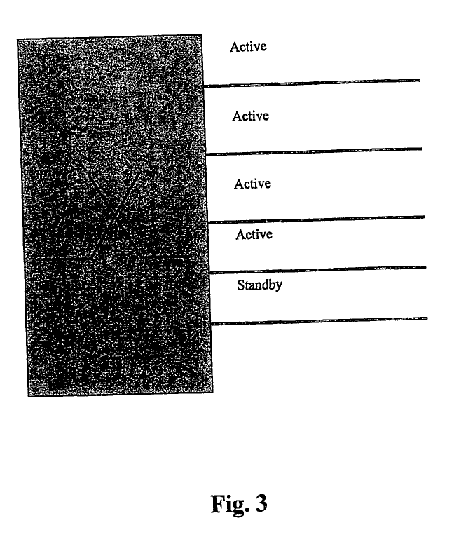

FIG. 4 is a schematic drawing of an exemplary arrangement with separation of protected and protection layers, MSP1+1/MSP1:1, according to the invention;

FIG. 5 is a schematic drawing of an exemplary arrangement with separation of protected and protection layers, MSP1:4, according to the invention; and

FIG. 6 is a schematic drawing of an exemplary arrangement with separation of protected and protection layers, SNCP, according to the invention.

### DETAILED DESCRIPTION OF EMBODIMENTS

In the following, by way of example, the invention will be explained in more detail

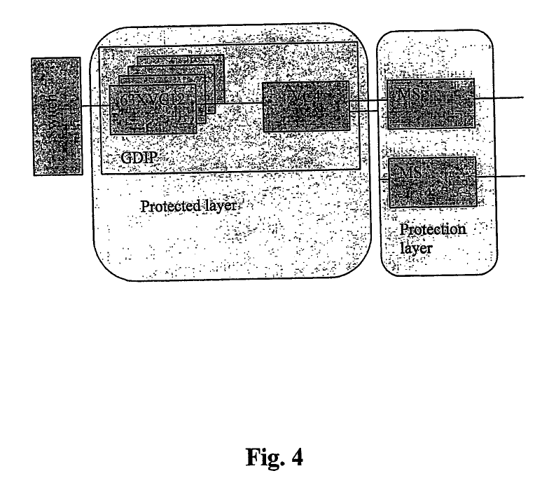

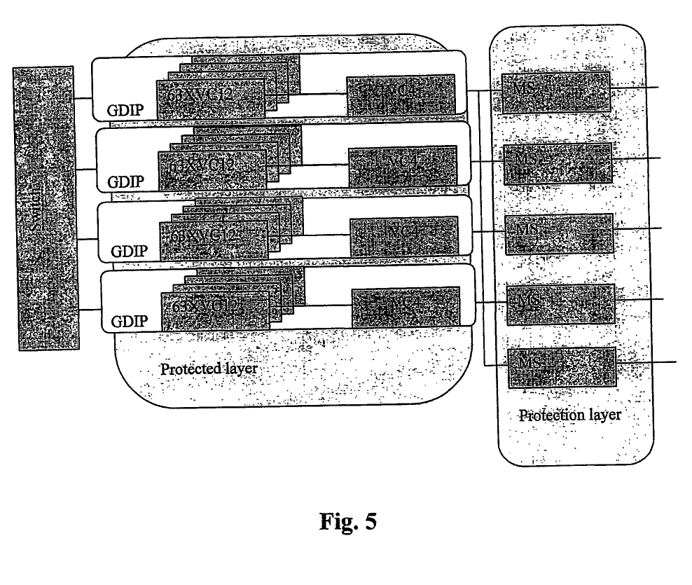

With reference to FIGS. 4 and 5, a new information arrangement or model according to the invention will introduce a new handling object, here referred to as GDIP, which, as illustrated, include one VC-4 object and 63 VC-12 objects (note that the number of objects in each layer may differ depending on standard ITU-T or ANSI, and termination level, STM-1, STM-4, or other). This means that, compared with the previously known solution, the protection layer, MS, is separated from the protected layers, VC-4 and VC-12. This is illustrated by two possible configurations, MSP1+1/MSP1:1, shown in FIG. 4, and MSP1:4 shown in FIG. 5, respectively.

Addressing through implementations of the new information arrangement or model according to the invention will be simpler with respect to the VC-4 and the VC-12 objects. These objects will be addressed using the GDIP, as shown in FIG. 5. GDIP has pointers to the contained VC-4 and VC-12 objects. It also has global state information representing the contained objects.

For the system example employed to illustrate the situation in table 1 above, an implementation of the invention in the same system would give the following results:

a) one table for the GDIP, and

b) one table for the MS.

The situation as presented to a supervisor or manager will then become as shown in the is following tables, table II and table III, respectively:

TABLE II

| GDIP | LAYER | STATE | BLS | FAULT | TYPE | PL/TTI | LST |
|---|---|---|---|---|---|---|---|
| gdip | | state | bls | | | | |
| | VC4 | state | bls | fault | type | pl/tti | lst |
| | VC12-0 | state | bls | fault | type | | lst |
| | VC12-1 | state | bls | fault | type | | lst |
| | . | . | . | . | . | | . |
| | . | . | . | . | . | | . |
| | . | . | . | . | . | | . |
| | VC12-63 | state | bls | fault | type | | lst |

TABLE III

| MS | STATE | BLS | FAULT | LST |
|---|---|---|---|---|
| MS | state | bls | fault | |

As can be seen from the examples above, the new information model arrangement gives a presentation that is much easier to read since it contains fewer objects. Also it is easier to understand the addressing because one GDIP object will contain only one VC-4, and all VC-12s in the presentation will belong to the same VC-4. This gives a more logical addressing format. Also, the presentation for the MS object is better because it contains information for only one MS. It will also be possible to assign logical names to the MSs

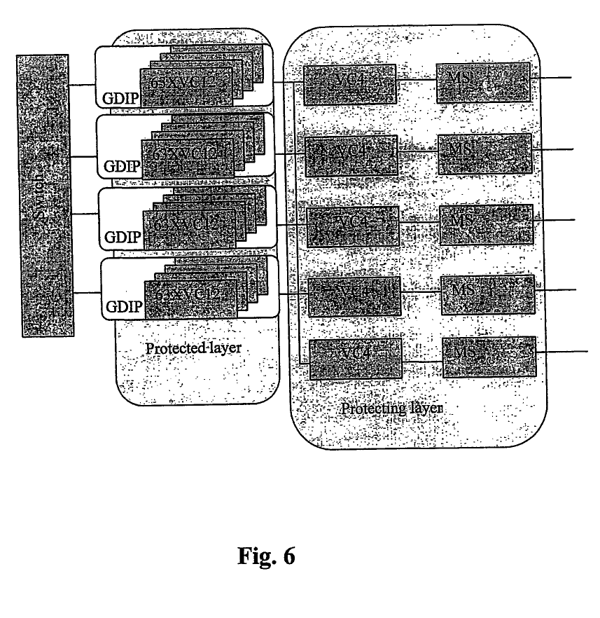

Since the MS objects are not contained in the GDIP object, they have to be addressed in a separate name space. The number of MS objects will correspond to the number of physically connected network terminations. If SNCP (Sub Network Network Protection) is used, the protection layer should be separated the same way as the MS objects in MSP (Multiplex Section Protection). As can be seen from FIG. 6, each group of 63 VC-12 belongs to the new object, GDIP.

### ADVANTAGES

The main advantages obtained by the invention are:

The new information arrangement (or model) supports any kind of multiplex section protection (MSP1+1, MSP 1:N and MSP N:M);

Flexible solution: The same arrangement model can be used to represent any protocol stack similar the SDH or SONET hierarchy;

Easier handling of SDH termination from a user or operator point of view;

Grouping of contained objects (VC-4 and VC-12) in accordance with the new arrangement gives the possibility to have global state information in the grouping object showing the status of the contained objects; and

Can be used for terminations following the ANSI (American National Standardisation Institute), the Japanese (TTC) and the ITU-T or ETSI (International Telecommunication Union or European Telecommunications Standards Institute) Standards or Recommendations. (Note that the naming of the contained objects differ in the mentioned markets).

The principles of the invention can also be applied for information models where SNCP (Sub Network Connection Protection) is used. That is, all protocols stacks having a protection—and a protected layer.

The invention may be used for any of the standards or recommendations specified by ITU-T, ANSI or TTC. I.e. it is applicable both for SDH and for SONET standards. Within the SDH and SONET hierarchy, there are also defined different levels of terminations. That is, for SDH there are defined STM-1 (155 Mbps), STM-4 (622 Mbps), STM-16(2.5 Gbps),etc., in SONET there are correspondingly OC-3 (155 Mbps), OC-12(622 Mbps), OC-48(2.5 Gbps),etc. However, the invention can be applied for all levels of SDH or SONET.

TERMS, ABBREVIATIONS AND REFERENCES

| ANSI | American National Standardization Institute |
|---|---|
| APS | Automatic Protection Switching |
| ETSI | European Telecommunication Standards Institute |
| GDIP | General Digital Path |
| ITU-T | International Telecommunication Union - Telecommunications sector |
| MS | Multiplex Section |
| MSP | Multiplex Section Protection |
| SDH | Synchronous Digital Hierarchy |
| SDIP | Synchronous Digital Path |
| SONET | Synchronous Optical Networks |
| SNCP | Sub-Network Connection Protection |
| STM-N | Synchronous Transport Module level N |
| TTC | Telecommunications Technology Committee (Japan) |
| VC-n | Virtual Container, level - n |
| PROTECTED LAYER: | A set of entities that are protected by a set of transport entities |
| | within a Protection Layer. E.g. the protected layer consists of 2 |
| | Mb/s paths, VC-12 paths and a VC-4 path protected by an |
| | MSP 1 + 1 arrangement. |
| PROTECTION LAYER: | A set of transport entities offering protection for a set of |
| | entities to be transported. E.g. the protection layer consists of |
| | Multiplex Sections in case of MSP 1 + 1 protection. |
| ITU-T G.707 | Standard document from International Telecommunication |
| | Union, Telecommunication Standardization Sector, “Series |
| | G: Transmission systems and media”, doc. no. ITU-T G.707 |
| | (03/96) |
| ITU-T G.783 | International Telecommunication Union, Telecommunication |
| | Standardization Sector, “Series G: Transmission systems and |
| | media, digital systems and networks”, doc. no. ITU-T G.783 |
| | (04/97) |
| ITU-T G.841 | International Telecommunication Union, Telecommunication |
| | Standardization Sector, “Series G: Transmission systems and |
| | media, digital systems and networks”, doc. no. ITU-T G.841 |
| | (10/98) |

### GDIP Realization

The following description shows how the new GDIP object can be realized. As an example it is showed how the GDIP can be realised for a MSP4:1 configuration.

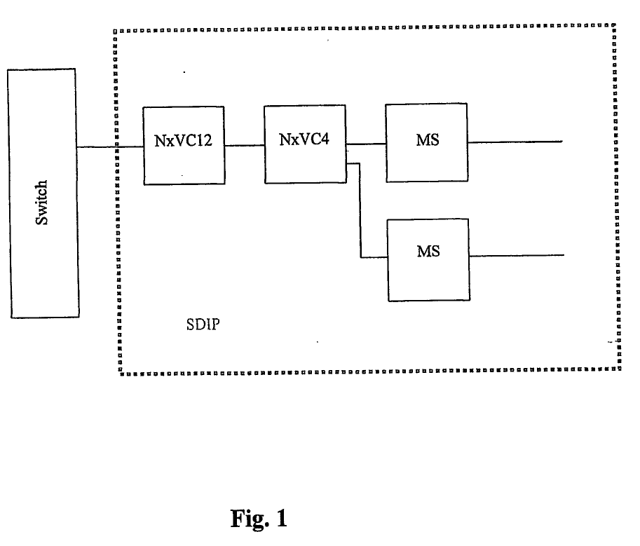

The new GDIP object has the task of grouping the protected objects in the network termination. In this example, the protected objects are the VC-4 and VC-12 objects, see FIG. 1.

The new GDIP Software (SW) object can be implemented with a number of SW record files illustrated with the tables as follows:

TABLE 1
GDIP SW Record file with its content

| | Pointer to | Pointer to | |
|---|---|---|---|
| GDIP object number | VC-4 file | VC-12 file¹ | Global State |
| 1 | 1 | 1 | GLSTATE#1 |
| 2 | 2 | 64 | GLSTATE#2 |
| 3 | 3 | 127 | GLSTATE#3 |
| 4 | 4 | 190 | GLSTATE#4 |
| 5 | 5 | 253 | GLSTATE#5 |
| 6 | 6 | 316 | GLSTATE#6 |
| 7 | 7 | 379 | GLSTATE#7 |
| 8 | 8 | 442 | GLSTATE#8 |
| 9 | 9 | 505 | GLSTATE#9 |
| 10 | 10 | 568 | GLSTATE#10 |
| 11 | 11 | 631 | GLSTATE#11 |
| N | N | N | GLSTATE#n |

¹Pointer to first VC-12 of each GDIP. Formula: (GDIP_object_number − 1) × 63 + 1

As seen in Table 1, each GDIP object has a pointer to a VC-4 file and a VC-12 file that are both belonging to the new GDIP software object. In the table there is also a Global state information which is described separately.

TABLE 2
VC-4 SW record file with its content. 1 VC-4 for each GDIP.

| | VC-4 object | |
|---|---|---|
| GDIP object | number. | VC-4 Blocking |
| number | Pointer | State info |
| 1 | 1 | VC-4 blstate |
| 2 | 1 | VC-4 blstate |
| 3 | 1 | VC-4 blstate |
| 4 | 1 | VC-4 blstate |
| 5 | 1 | VC-4 blstate |
| . . . | . . . | VC-4 blstate |

Note here that there is a one-to-one relation between the GDIP object and the VC-4 object in this example. For this reason the SW file (Table 2) could be omitted and the pointer to the VC-4 object could be included in the GDIP file. The table can also include a pointer to another SW record file which has all the relevant information for each VC-4 (with information according to earlier implementation known by Ericsson and according to standards/recommendations).

Typical information for each VC-4 class is: VC-4 administrative state, fault information, blocking state, alarm classes, etc.

The maximum file size of VC-4 SW record (Table 2) is equal to the number of GDIPs, since there is only one VC-4 for each GDIP in this example.

TABLE 3
VC-12 SW record file with its content. 63 VC-12 for each GDIP.

| | | VC-12 object | |
|---|---|---|---|
| | | number. Relative | |
| Record | GDIP object | addressing.² | VC-12 Blocking |
| Pointer | number | Pointer | State info |
| 1 | 1 | 1 | VC-12 blstate |
| 2 | 1 | 2 | VC-12 blstate |
| . . . | 1 | . . . | VC-12 blstate |
| 63 | 1 | 63 | VC-12 blstate |
| 64 | 2 | 1 | VC-12 blstate |
| 65 | 2 | 2 | VC-12 blstate |
| . . . | 2 | . . . | VC-12 blstate |
| 126 | 2 | 63 | VC-12 blstate |
| 127 | 3 | 1 | VC-12 blstate |
| 128 | 3 | 2 | VC-12 blstate |
| . . . | 3 | . . . | VC-12 blstate |
| 189 | 3 | 63 | VC-12 blstate |
| 190 | 4 | 1 | VC-12 blstate |
| 191 | 4 | 2 | VC-12 blstate |
| . . . | . . . | . . . | VC-12 blstate |
| 252 | 4 | 63 | VC-12 blstate |

²Relative addressing here means that VC-12 are numbered 1 to 63 for each GDIP

The table can also include a pointer to another SW record file which has all the relevant information for each VC-12 (with information according to earlier implementation known by Ericsson and according to standards/recommendations). Typical information for each VC-12 class is: VC-12 administrative state, fault information, blocking state, alarm classes, etc. The maximum file size of VC-12 SW record (Table 3) is equal to 63×(number of GDIPs).

By using the SW record files, the GDIP has defined the relations to the VC-4 and VC-12 objects that belongs to GDIP itself.

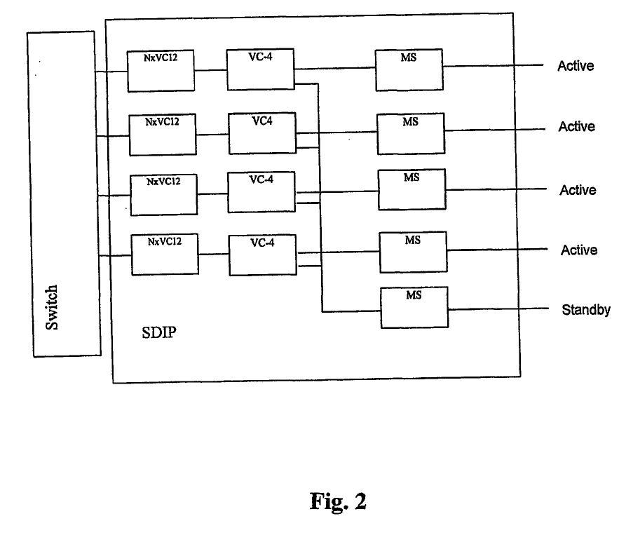

As an example VC-12 number 2 (VC-12-2) of GDIP number 4 is then calculated as follows (see illustration FIG. 2):

Table 1 gives that the first VC-12 of GDIP number 4 has pointer equal to 190

Using Table 3 and incrementing the “Record pointer” by one (since it was VC-12 number 2 of GDIP number 4 we wanted), we find the VC-12-2 of GDIP number 4

Without the invention, the same VC-12 would be addressed as VC-12-191 of the group of protected VC-12s (using existing SDIP concepts of Ericsson). In this case it is also more difficult to see which VC-4 a specific VC-12 belongs to (i.e. without the grouping into GDIP).

Note that the tables given in this description is shown with a minimum of information with the purpose of illustrating the addressing principles of objects (VC-4 and VC-12) within a GDIP. Each object (VC-4 and VC-12) in a real application will contain more data for each entry.

The Global State of the GDIP can be used to present the overall status of the contained objects. The global state of the GDIP can be derived using the following examples of rules:

TABLE 4
Derivation of GDIP Global State based on the corresponding
VC-4 and VC-12 blocking states.

| GDIP Global State | VC-4 Blocking State | VC-12 Blocking State |
|---|---|---|
| Working | Working | Working |
| Blocked | Blocked | Blocked |
| Partly Blocked | Working | 1 or more (up to 63) |
| | | VC-12 are NOT blocked |

The GDIP Object calculates the Global State by checking the blocking state for each of the objects (VC-4 and VC-12) that are related with the GDIP object. Without the proposed invention, the blocking state for each involved object will be presented individually giving very extensive printouts. The grouping proposed gives a short and compact presentation, especially for the “all working” or “all blocked” cases. In addition then, as an option the traditional presentation of each subobjects blocking state can be presented to give the detailed view of each objects.

### Interfaces of the GDIP

The GDIP object will have the following interfaces:

Operator interface for presentation of GDIP internal relations (i.e. in order to show the objects grouped by each GDIP object), and for presentation of the Global State information, etc.

Interface to other transport layer, e.g. Digitial Path (2 Mbps signal carrying 32 timeslots of 64 kbps each)

Interface to “Protecting Layer”, i.e. interface to the Multiplex Section (MS) objects or to an object representing the network protection functionality, i.e. existing part of the telecom system that provide the network redundance. This other object or part of the system handle itself the status and actions of the network protection function.

[image]

[image]

### Clarification of the terms “Global State” and “Global Addressing”

Global adressing

With global addressing it is meant that an object is given an address from the global addressing space. In the patent application we have described the global addressing of VC-12 and VC-4 objects as a problem. By introducing the overlying object GDIP we can give the VC-12 and VC-4 objects addresses relative to the GDIP. This gives a much better picture of the objects related to the network and physical interfaces.

Global state

Global state of an object is the state of operation the object is in. As an example we can use an object with sub objects like the GDIP. We can define the following global states for this object (as an example):

Working: All underlying objects are working.

Partly blocked: Some underlying objects are blocked.

Blocked: All underlying objects are blocked.

1. An arrangement for object handling in object supervision, operation, monitoring, control, management or the like in redundancy protected networks according to SDH or SONET comprising a plurality of protected items and at least one protection item, characterised in that at least one group of first information objects representing linked protected items is globally addressable by means of at least one respective GDIP object, said first information objects being addressable relative to said GDIP object.

2. An arrangement according to claim 1, characterised in that second information objects representing said protection items are globally addressable.

3. An information data object in redundancy protected networks according to SDH or SONET comprising one or more protected items and protection items, characterised in that the information data object, in use, is a GDIP object being identifiable as an addressable data structure held in one or more registers in a computer and comprises pointers to a set of objects representing protected items.

4. An object arrangement in a redundancy protected network according to SDH or SONET for improved supervision, operation, monitoring, control, management or the like of network items represented by objects, the objects being according to ITU-T, ETSI, ANSI and/or TTC standards, characterised in at least one globally addressable GDIP object, each said at least one GDIP object being an information object for information pertaining to a set of associated objects, the set of associated objects representing a plurality of terminations essentially at a level according to ITU-T VC12 and one termination essentially at a level according to ITU-T VC4.

5. An object arrangement according to claim 4, characterised in that each object contained in said set of associated objects is addressable relative to an address of the associated GDIP object.

6. An improvement in a redundancy protected network according to SDH or SONET, characterised in that the improvement includes layering objects representing terminations into at least one protected layer for protected terminations and at least one protection layer for protecting terminations, and
grouping objects representing linked terminations of the at least one protected layer by means of relative addressing into one ore more respective GDIP objects.
